(19) United States
(12) Patent Application Publication
(10) Pub. No.: US 2018/0135830 A1
(43) Pub. Date: May 17, 2018

(54) LED GROW LIGHT

(71) Applicant: Eye Lighting International of North America, Inc., Mentor, OH (US)

(72) Inventors: Dengke Cai, Willoughby, OH (US); Paul J. Jurkovic, Painesville, OH (US); Thomas G. Salpietra, Concord Township, OH (US); Michael A. Anderson, Richmond Hts, OH (US); Gina C. Lowers, Richmond Hts, OH (US); Shoushirou Sugio, Gyoda-shi (JP); Tsuyoshi Toudou, Gyoda-shi (JP); Hideaki Ishihara, Gyoda-shi (JP); Hiroyuki Matsumoto, Gyoda-shi (JP); Akira Kosasa, Gyoda-shi (JP)

(21) Appl. No.: 15/814,390

(22) Filed: Nov. 15, 2017

Related U.S. Application Data
(60) Provisional application No. 62/422,526, filed on Nov. 15, 2016.

(51) Int. Cl. F21V 3/06; A01G 7/04

(52) U.S. Cl. CPC F21V 3/061; F21Y 2115/10; A01G 7/045

(57) ABSTRACT

A horticultural lamp with multichannel LEDs including UVA and near IR (providing an extended range of wavelengths of about 315-800 nm) uses a fluoropolymer diffusing lens to enable excellent transmittance (80 to 90%) of light throughout the extended range while diffusing to create a substantially uniform spectrum throughout the illuminated area by mixing the individual LED wavelength outputs independently of discrete positioning of LEDs on the LED carrier.

### CROSS-REFERENCE TO RELATED APPLICATIONS

This application claims the benefit of U.S. Provisional Patent Application No. 62/422,526, filed Nov. 15, 2016, said application hereby incorporated in its entirety by reference herein.

### BACKGROUND OF THE INVENTION

The prior art knowledge base ranges from longstanding assumptions about PAR lighting and a plant sensitivity curve known as the McCree curve which is generally believed to be representative of most chlorophyll-using plants; to experimentation and commercial growers' experience concerning commonly used horticultural light sources such as metal halide, High Pressure Sodium (e.g., 1000 W HPS), and various fluorescent lamp designs and combinations (e.g., the PowerVEG™ system).

Some recent prior art work has looked at plant growth under LED lighting which can be more finely tuned than the other prior types of lighting, for example U.S. Pat. No. 6,921,182 by Anderson, Jr. et al., who tested growth of plants such as cotton and miniature roses, and concluded that “Red” (660 nm) and “Orange” (612 nm) plus a small amount of 465 nm “Blue” (8% of the total red flux) worked best, and furthermore concluded that “Lime Green” (570 nm) was not important and could be left out.

It is an objective of the present work to develop an adjustable spectrum LED lamp that can output adequate radiant power for horticultural use, and is adjustable to optimize the output spectrum for different stages of plant growth, vegetation, bloom/budding, etc.

### BRIEF SUMMARY OF THE INVENTION

Our work focused on development of an adjustable spectrum LED lamp that could output adequate radiant power for plant growth with up to 7 separately adjustable wavelength channels that covered a suitable range of wavelengths. Although prior art horticultural lamps have focused on the “PAR” spectral range of 400-700 nm, we determined that the range should be extended on both ends to about 350-800 nm. Therefor we have added a UVA channel supplied by an LED covering the 350-400 nm range (e.g., a 365 nm LED), and a Far Red channel of 700-800 nm (e.g., a 730 nm LED).

Although most channels are covered by using LEDs emitting in a narrow band, the wavelengths between “blue” and “red” are covered by two broad spectrum LEDs that peak around 530 “green” and 620 “orange” and have tails that help boost output from violet to near IR. The orange LED is sold as a “2200K color T” which also happens to be similar to an HPS (High Pressure Sodium) lamp output spectrum.

The prior art work documented in U.S. Pat. No. 6,921,182 by Anderson, Jr. et al., who tested growth of plants such as cotton and miniature roses. He concluded that “Red” (660 nm) and “Orange” (612 nm) plus a small amount of 465 nm “Blue” (8% of the total red flux) worked best, and furthermore concluded that “Lime Green” (570 nm) was not important and could be left out. Thus he kept his study within the PAR spectral range determined by the McCree curve, which has peaks in blue and red but remains relatively high in between (i.e., yellow and green). Anderson focused on promoting photosynthesis and carotenoid synthesis, which have peaks in the red and blue wavelengths, so this may be why he reported that green light wasn't needed. We have determined otherwise.

Our channel selection and quantities of LEDs in each channel have been determined as described in the provisional priority document so that maximum power of each channel will provide a suitable amount of output intensity in each wavelength band, with emphasis on what we expected would be the most desirable wavelengths for plant growth. This has been confirmed by using a prototype lamp embodiment as a source for testing plant growth under different spectral distributions.

A diffusing lens and/or reflector was needed to provide uniformly mixed LED wavelengths across a horizontal plane as close as 30 cm distance from the lens. Various means for diffusing the radiant output were determined, and selection among them depends upon transmittance versus wavelength, with cost being a secondary consideration. In particular, a glass lens causes significant loss of longer wavelengths, especially in the Far Red/Near IR extended range above 700 nm. Polycarbonate (PC) polymer has reasonable IR transmittance, but has a sharp cutoff around 400 nm that excludes the UVA extended range. Fluoropolymers have excellent transmittance for IR and only gradually decreases in the UV region. Therefor our full (extended) range horticultural lamp (grow light) has a fluoropolymer lens. Regarding diffusion, we have developed cost effective fluoropolymer shapes, sizes, and chemical compositions that adequately diffuse all of our spectrum channels while transmitting and/or reflecting the radiation.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different versions of an element 109 which are similar or related in some way but are separately referenced for the purpose of describing modifications to the parent element (109). Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is a graph showing a spectral distribution known as the McCree curve and example LED wavelength ranges for spectrum fitting according to the invention.

FIG. 2 is a graph showing the spectral distribution of a. “BTU Blue” 1000 W HID lamp, and example LED wavelength ranges for spectrum fitting according to the invention.

FIG. 3 is a graph showing spectral distributions for seven example LEDs proposed for spectrum fitting according to the invention.

FIGS. 4A and 4B are graphs showing spectral output of LEDs selected for a seven channel embodiment of an adjustable spectrum LED grow light according to the invention.

FIG. 5 is a perspective, top and side view of an LED grow light according to the invention.

FIG. 6 is a schematic view of an LED carrier backplane showing positioning of mounted LEDs according to the invention.

FIG. 7 is a table summarizing information about the LEDs used for the adjustable channels of an adjustable spectrum LED grow light according to the invention.

FIGS. 8A-9B show measured intensity of each wavelength versus horizontal displacement under glass versus frosted glass lamp lenses.

FIG. 10 shows the transmittance versus wavelength of glass versus two polymers.

FIGS. 11A-C show side sectional views of lamps with different lenses, frosted glass, fluoropolymer, and polymer with grooves.

FIGS. 12A-C show a side sectional view plus details of the carrier surface and the reflector.

FIGS. 13A-B show a side sectional and a top view of a lamp showing cooling.

FIG. 14 is a vertical cross-sectional view of a schematic representation.

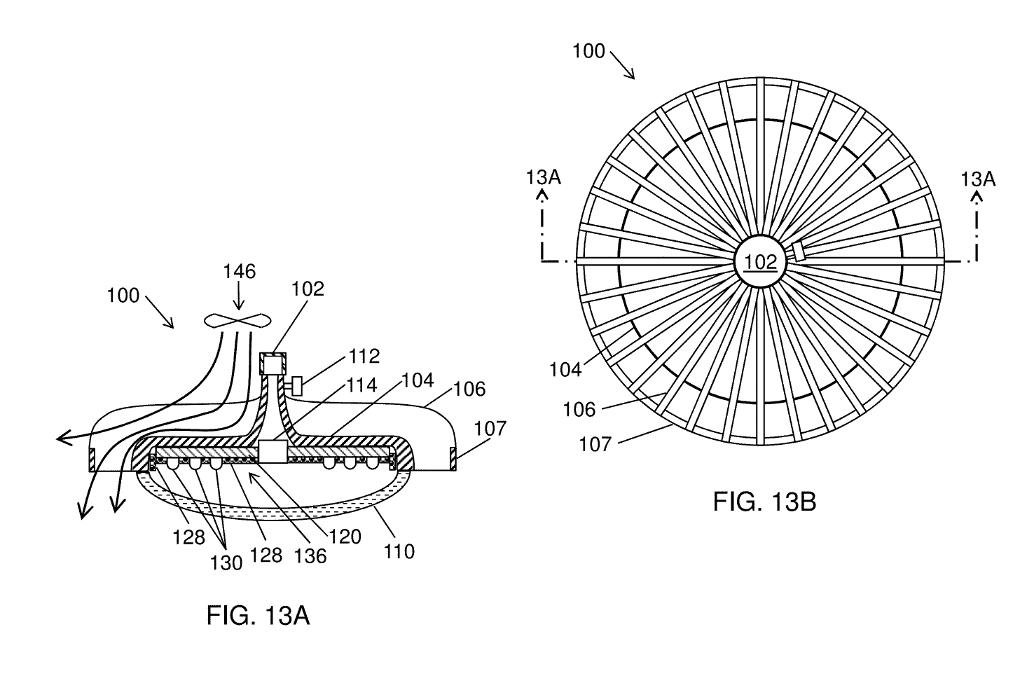

### DETAILED DESCRIPTION OF THE INVENTION

The following table is a glossary of terms and definitions, particularly listing drawing reference numbers or symbols and associated names of elements, features and aspects of the invention(s) disclosed herein.

| REF. | TERMS AND DEFINITIONS |
|---|---|
| 100 | multi-spectrum LED grow light (horticultural light) |
| 102 | base, lamp mounting |
| 104 | housing, body |
| 106 | heat sink, fins |
| 107 | outer ring of heat sink fin structure. Optionally extended upward to deflect/direct heated |
| | air flow toward plants |
| 108 | inside wall of housing, LED chamber |
| 110 | lens, front cover over LED module. Preferably diffusing unless diffusing reflector 128 is |
| | used. |
| 111 | groove, indent, thinned portion of lens 110. Used to vary diffusion of light passing |
| | through lens. |
| 112 | spectrum selection switch or external control (e.g., remote/wireless, wired control panel, |
| | computer . . . ) |
| 114 | multichannel LED driver for separate adjustable output control of each LED channel, |
| | e.g., custom module with multiple DMX controllers. Optionally incorporated into lamp |
| | body, or mounted on the PCB (driver on board), or implemented as an external module. |
| | May have both internal and external components. |
| 120 | LED carrier/backplane, PCB (e.g., MCPCB) for mounting LEDs. Generally circular and |
| | planar to fit into round lamp housing. |
| 122 | dielectric layer on PCB |
| 124 | circuit trace layer |
| 126 | optional solder mask |
| 128 | Reflector, preferably a diffusive reflector (e.g., PTFE fluoropolymer). May be on inside |
| | wall 108 around the LED module, or on top of the PCB (with holes for the LEDs). |
| 130 | LEDs mounted on the PCB 120 to form an LED module 136 within the lamp 100. |
| a-f1, f2 | Different wavelength LEDs (types) are distinguished by different letters as a suffix. In an |
| | embodiment with seven LED types there are LEDs 130a to 130f2. The suffix letters also |
| | correspond to the ring 132 in which they are mounted. In a six ring embodiment, the |
| | LEDs 130a to 130f2 are mounted in rings 132a to 132f respectively. (Two different LED |
| | types: 130f1 and 130f2 are in the same ring 132f). |
| 132 | Ring, circular arrangement of LED mounting positions at a particular radius (X) from the |
| a-f | center axis 134 of the lamp (center of circular PCB). Different rings and their radii are |
| | designated by suffix letters a, b, c, d, e, f for the outermost ring 132a at radius X(a), to |
| | the innermost ring 132f at radius X(f). |
| 134 | Lamp axis |
| 136 | LED module = LEDs 130 mounted on carrier/PCB 120 |
| 146 | fan for forced air cooling of lamp/heat sink |
| OD | outside/overall diameter of lamp 100 |
| OAL | overall length of lamp |
| X | horizontal/radial distance from lamp axis 134 = center of lamp LED module 136 where |
| | lamp axis is vertical when lamp is in use.) Radii of rings 132a to 132f are labeled X(a) to |
| | X(f). |
| Z | vertical distance below lamp face (outside surface of lens/cover 110). The Z-axis is |
| | parallel to lamp axis 134, and normal to plane of the PCB 120 |
| Dpcb | Diameter of PCB inside the lamp 100 |

The invention(s) will now be described with reference to the drawings using the reference numbers and symbols listed in the above table.

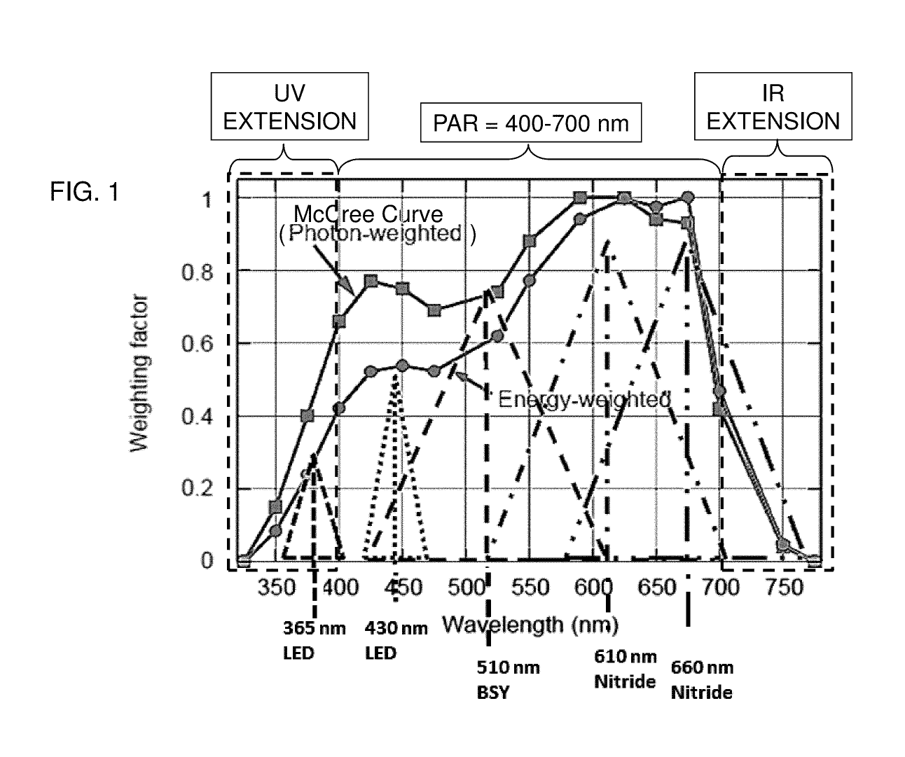

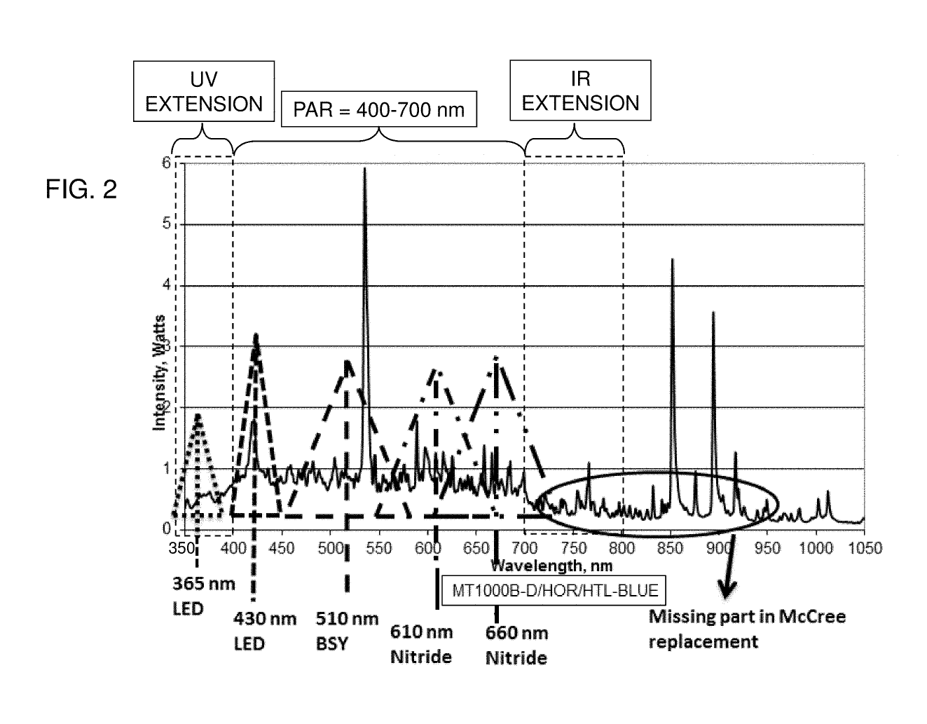

The provisional application/priority document shows that the herein disclosed LED Grow Lamp resulted from development of what was first described as a “ . . . spectrum tunable solution for highly efficient LED lighting that may be applied to achieve special purpose lighting for a variety of lighting applications that may include, but are not limited to “grow light” products.” The original objective for a “grow light” was to use LEDs to “at least match the McCree curve and the Eye lighting BTU Blue HID products” (see FIGS. 1-2). The McCree curve has been used to support a definition of “Physiologically Active Radiation (PAR)” as 400-700 nm (nanometers) wavelengths, and amount of PAR output has long been a benchmark indicator of expected effectiveness for horticultural light sources, to the point that “PAR meters” are light meters that are limited to only measure radiant power within the range of 400-700 nm. However, as shown in FIGS. 1-2, the McCree curve actually extends beyond those limits, albeit tailing off from about 40% to zero intensity within the next 70-100 nm of range extension. Also the BTU Blue lamp, which is considered a good horticultural light source, has significant radiant output far out into infrared wavelengths and also some UV. This lead us to consider LEDs that would add the extended wavelengths not covered by the PAR definition. For example, FIGS. 1-2 show how five LEDs can be used to approximate the McCree curve or the BTU Blue lamp within an extended range of about 300-800 nm.

Ultimately our work became focused on a multi-spectrum lamp, particularly one that could output sufficient quantities of “light” (radiant output) in a variety of spectral distributions useful for horticulture as a “grow light”. The work included determination of wavelength ranges (channels) that should be included so that spectral output can be adjusted to encourage all stages of plant growth for a variety of plants.

LED Color & Spectrum

LEDs are limited due to lack of efficiency in UVB region and thermally unstable in NIR (near infrared). We initially targeted to use LEDs and their phosphor combinations to simulate the McCree curve from 400-700 nm (FIG. 1) and Eye Lighting's “BTU Blue” HID products (e.g., MT1000B-D/HOR/HTL-BLUE) from 300 nm to 800 nm (FIG. 2). The figures show example LED wavelength ranges superimposed on the spectral distribution curves.

The basic approach is how to best utilize multi-channel driven LED/phosphor combination by considering the EQE of LEDs, QE of phosphor and possibility to tune in a broad range like between McCree curve fitting and BTU blue.

The major spectrum can be divided into three important areas of consideration, UVA-blue ending 480 nm, green/yellow area from 480 nm to 600 nm, and yellow to far red area from 600 nm to 800 nm.

For UVA LED like 365 nm LED, due to relatively lower EQE (40% vs. 65% of 450 nm LED), longer stokes shift if combining with phosphors and less intensity required to match both spectra, we propose individual channel for it without combining with any phosphors.

For other violet and blue area, 420 nm and 450 nm peak emission LEDs are selected, which is first to match BTU blue 420 nm peak and utilize them having high excitation efficiency for most of green and red phosphors.

The second important area is green/yellow area. Blue shifted YAG with peak emission from 505 nm to 525 nm is selected to cover emission in green and compensate some area in blue-green, which sharp blue LED cannot cover. In addition, highly thermal/environmental stability and QE from YAG is also another reason to choose. Due to narrow FWHM (around 20-25 nm) from LED emission, combination of 450 nm LED emission and emission from blue shifted YAG on 500 nm cannot compensate well the difference between LED spectrum and McCree curve. Alternative to 450 nm LED, 470 nm or around LED can be selected to excite red phosphors discussed below, which is also from its high QE and absorption at 470 nm for red phosphors.

A third important area is yellow/red area. Two red phosphors with peak emission starting from 600 nm to 670 nm are selected to cover emission from 580 nm to 800 nm, esp. area from 580 nm to 680 nm which has highest PAR efficiency area. The reason to choose 670 nm and beyond peak emission far red phosphor is also to target to match BTU blue products, which have significant intensity till 800 nm. The potential candidates with high QE and thermal-environmental stabilities are nitride based phosphors.

As explained, we propose to use 420 nm violet or 450 nm or 470 nm around blue to excite green and red phosphors, and combine them and 365 nm UVA to create dynamic tunable plant grow light. The excitation wavelength with relevant QE for BSY and red nitride phosphors should be considered.

For BSY phosphor, the relative QE for 420 nm is around 80% to 450 nm.

The excitation wavelength and relative QE for red nitride phosphors has a much flatter excitation spectrum compared with BSY from 400 nm to 450 nm and its QE at 420 nm is around 90% to 450 nm. But, 420 nm LED has slightly lower EQE than 450 nm LED and longer stokes shift from 420 nm to red region, it might be less efficient than proposal: 450 nm LED+Nitride and 420 nm+BSY. Some practical experiments need to be performed to determine most efficient combinations or determine whether 420 nm LEDs stand alone as individual channel.

FIGS. 1-3 show individual color channel selections that could cover a 300-800 nm extended range.

Proposed channels that utilize the LED/phosphor combinations described above may be:
365 nm LED—UVA channel
420 nm LED—blue channel
420 nm or 450 nm LED around+BSY—green channel
420 nm or 450 nm LED around+Nitride—red channel
420 nm or 450 nm LED around+BSY+Nitride—over all McCree channel

Or the following may be the best combination for control of the full extended range:
365 nm LED—UVA channel
420 nm LED—Blue channel
450 nm LED+510 nm PE BSY—Green channel
470 nm LED+600 nm Nitride+670 nm Nitride—Red channel
   Phosphor Suppliers:
BSY: GTP, Merck, Nemoto, Mitsubishi & Intematix
Nitride: Dow, Mitsubishi & Intematix

By comparing with McCree curve alone, the LED spectrum above has 97% utilization PAR efficiency, especially in the visible to far red region. In addition, the 365 nm LED and the phosphor expanded red channel add good coverage of the UV and IR extensions. (The 510, 600, and 670 nm LEDs all extend beyond the 700 nm PAR limit.) In brief, this proposal provides color controllable grow light covering UVA, violet blue, blue pumped green and blue pumped red, which requires 3-4 driving channels.

LED Package and Phosphor Layer

With LED driving current increase, emission of phosphors increases respectively till their saturation. In this disclosure, we claim to utilize this unique performance from phosphors in LED package to adjust the ratio between LED excitation wavelength intensity and packaged phosphors intensity.

The phosphor saturation is determined by:
Weight of phosphors in encapsulation layer
Ratio between individual phosphor
Excitation wavelength and intensity

An example can be given: an LED package with violet or blue LED dies and certain green, yellow and red phosphors combination, at driving current 100 mA, all or partly blended phosphors in encapsulation inside LED package reach their saturation intensity, i.e. no matter how to increase driving current further LED phosphor intensity will not increase, but the LED intensity in violet/blue region will still keep increasing due to increase of driving current. When driving current is adjusted to 150 mA, the increased intensity from this package will majorly from violet/blue pump LEDs and phosphor emission still keep in the level of 100 mA. We can use this performance of LED package and phosphors to adjust violet/blue intensity for additional growth requirement in the extended blue/UVA region, and changing the ratio between violet/blue and green/red without using additional LED counts and channels to dynamically control the ratio between violet/blue and green/red.

Expanded Multi-Spectrum Channels

Instead of simply a “grow light” having a PAR output tailored for plant growth by matching the McCree curve a broader objective may be entitled a “multi-spectrum” lamp. A further objective is to achieve this, as much as possible, using various combinations of LEDs and phosphors that have radiant output in selected wavelength “channels”. Furthermore, we have explained that we have extended the range of wavelengths to be covered by our spectrums beyond the standard PAR range to wavelengths from 300 or 350 nm UVA to 800 nm NIR (near infrared) a.k.a. FR (far red). The description above describes a “color controllable grow light covering UVA, violet blue, blue pumped green and blue pumped red, which requires 3-4 driving channels” and presents several options wherein a combination of channels is selected to provide different “grow light” output spectrums.

The objective of a “multi-spectrum” lamp extends the mixed channel spectrum concept in a way that will provide other desirable spectrums, particularly different spectra for various phases of plant growth: e.g., sprouting and/or rapid growth, leafing, fruit-producing and the like.

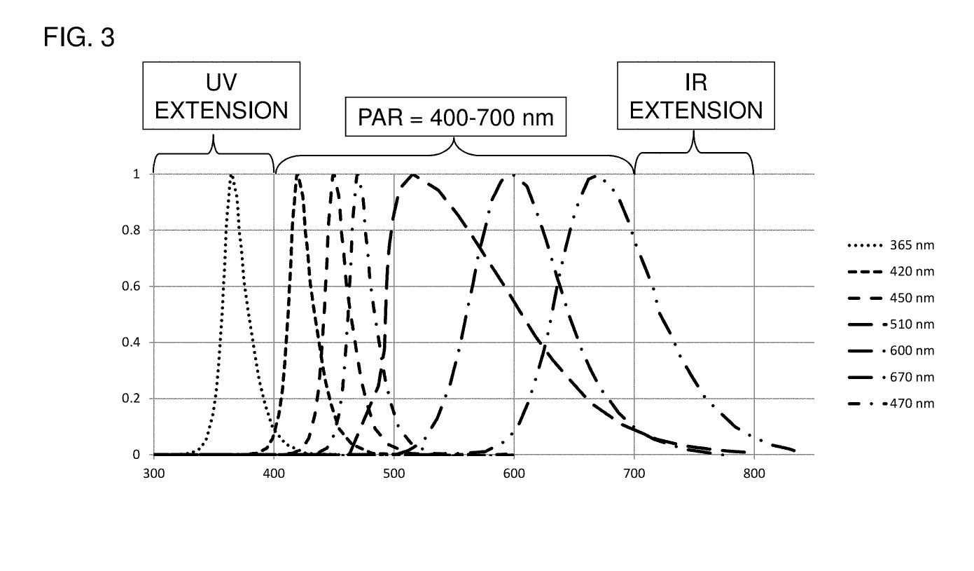

To achieve such a broader range of spectra the number of wavelength channels is increased from the 4 or 5 channels described above. An optimum set may be 7 channels, as described hereinbelow. In order to allow effective adjustment of individual channels, though, we would like to avoid significantly overlapping LED output ranges such as are obtained by using phosphor enhanced LEDs. For example, FIG. 3 shows 7 channels, but the wavelengths 500-800 nm are covered by 3 significantly overlapping range LEDs, with no peak values above 670.

Therefor we now look at more practical LED selections for optimizing adjustability throughout the range. The following channel listing enables a multi-spectrum lamp that may be tuned to emit a wide variety of spectra suitable for all stages of plant growth.

Spectrum variation may be achieved, for example, by selecting a particular combination of channels and may be further modulated by adjusting the power of each channel. Such adjustments to a channel may be made, for example, by turning on a particular quantity of the LEDs in the channel and/or by varying the LED current using a dimming driver circuit. In particular we utilized DMX drivers 114.

The channel wavelength ranges are all achievable with adequate output power using existing LEDs and phosphors. Examples of LEDs and phosphors plus methods for selecting and combining them in order to achieve a desired wavelength output are disclosed hereinabove. The following revised listing of channels primarily shows the channel wavelength bounds. They are followed by suggested LEDs and phosphors

The seven channels of the new multi-spectrum lamp are as follows:

I. UVA channel (350-380 nm): 365 or 375 nm LED
II. Violet channel (400-415 nm): 400 or 405 or 410 or 415 nm LED
III. Blue channel (440-460 nm): 450 nm LED
IV. Green channel (515-545 nm): using a phosphor with a 30 nm FWHM
V. Orange channel (2200 deg K color T): using a broad band phosphor having a minor peak at 450 nm and a major peak at 610 nm.
VI. Red channel (660 nm): 660 nm LED
VII. Near IR (Far Red) channel (730-760 nm)

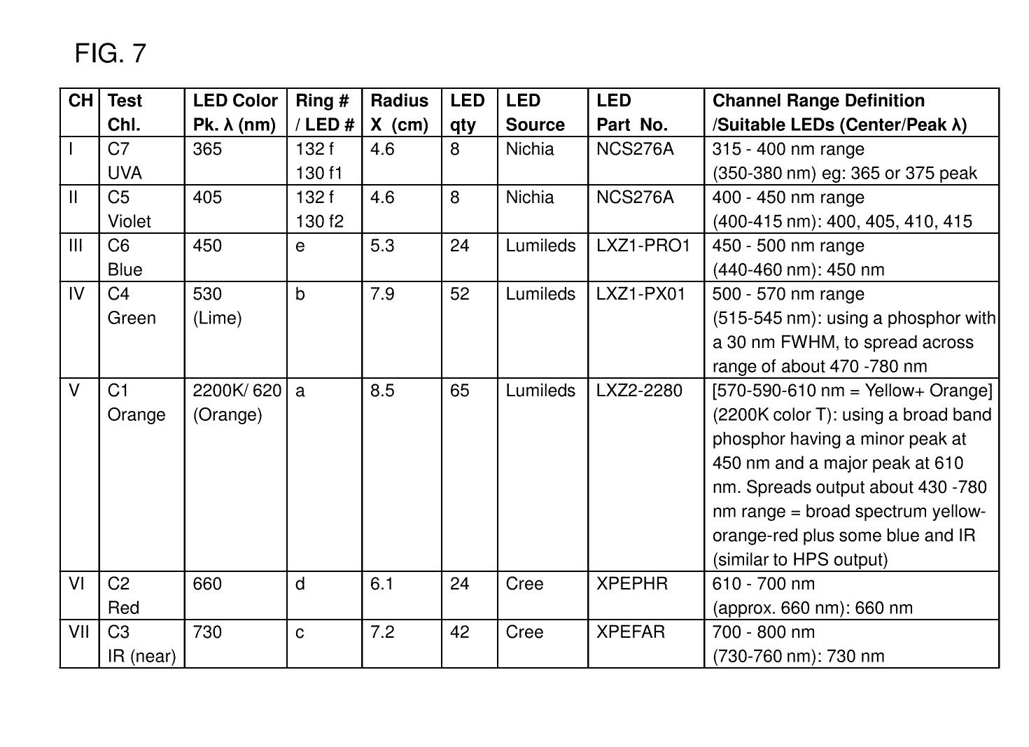

This listing is also made part of an information summary table included in the drawings as FIG. 7.

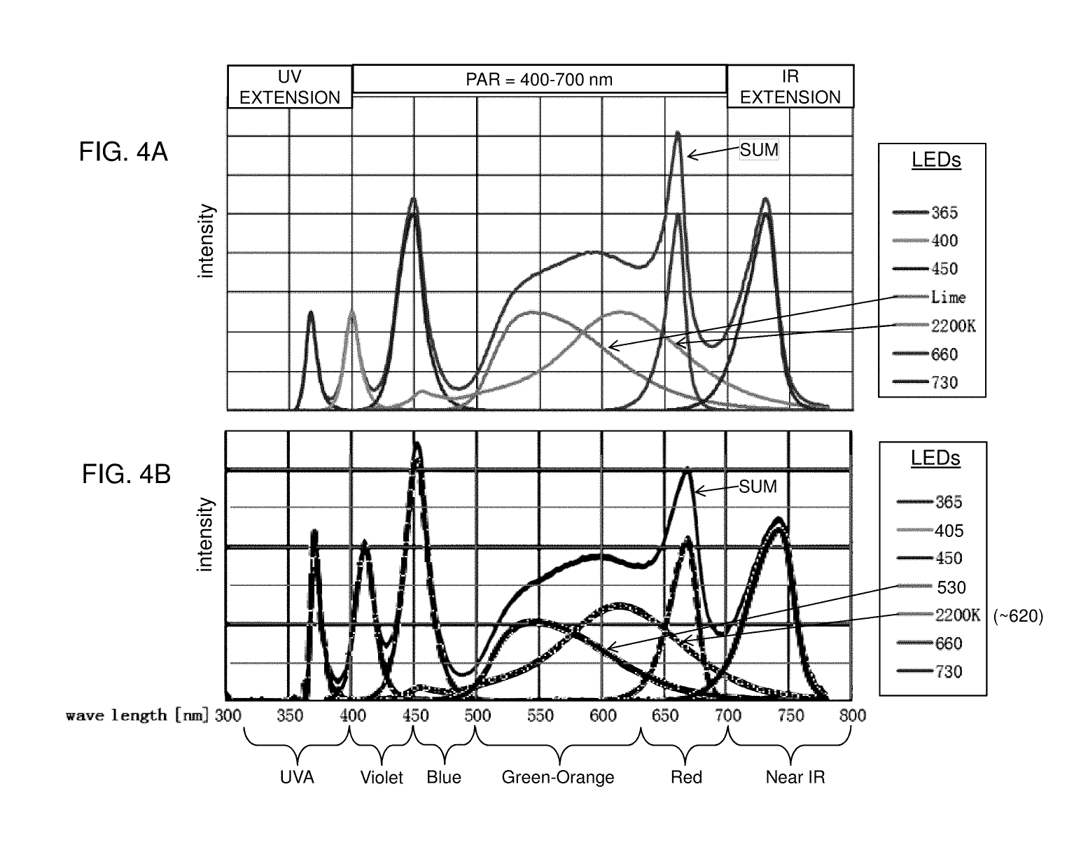

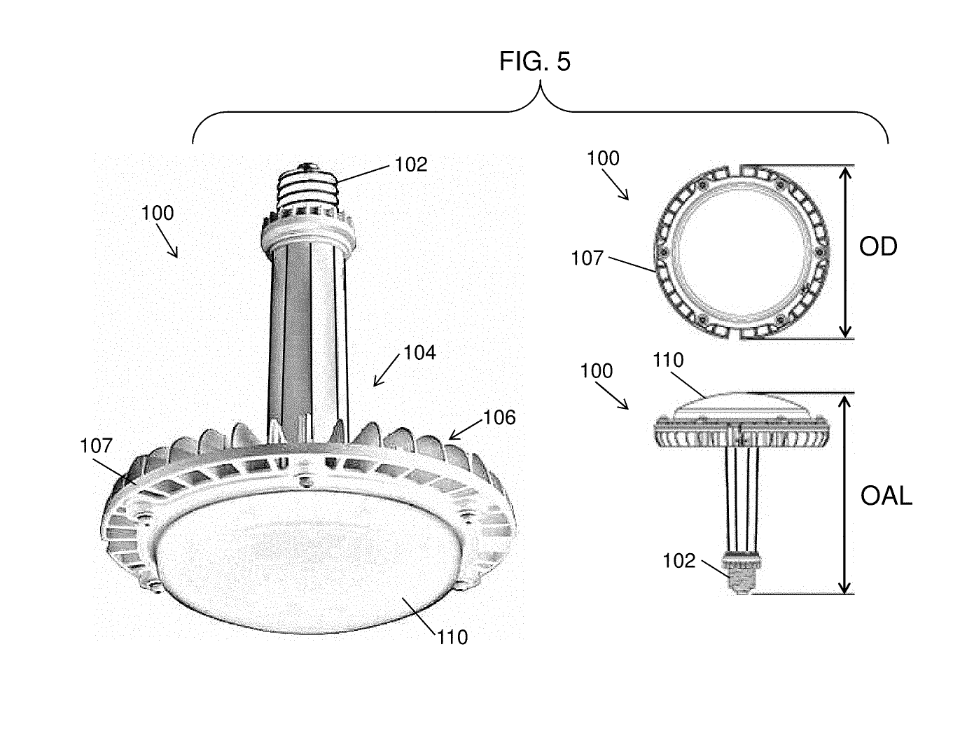

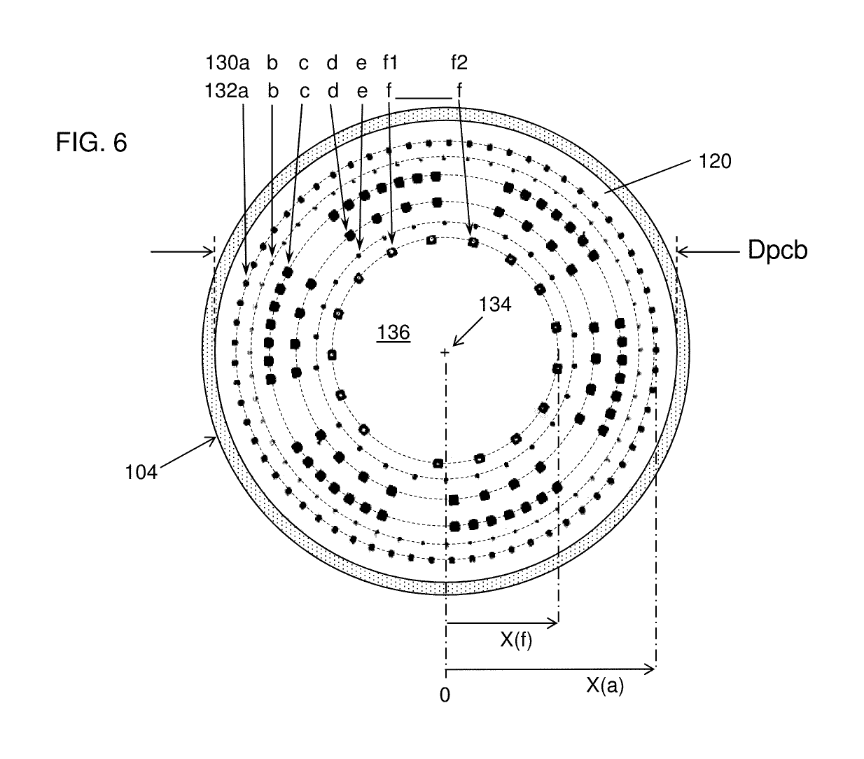

A prototype embodiment of a lamp having these 7 channels is shown in FIGS. 5-6. Example output spectra and listing of LEDs is in FIGS. 4A, 4B and 7. FIGS. 4A-B show the output of each LED when operated at maximum power, and then the curves are plotted together and added to create the “SUM” curve. The sum curve has been confirmed by measurements on a lamp with all LEDs operating at maximum. Various combinations obtainable by separately adjusting the channels have also been measured.

The listing of LED quantities, suppliers and their part numbers are provided as a non-limiting example of a way to achieve spectral distributions such as those shown in FIGS. 4A-4B. Inventive claims may be made to the number of adjustable channels, to the channel wavelength ranges, to the relative magnitudes of channel peaks at max adjustable power. We may also claim specifics about discrete LED types that control adjustability of one or more channels.

We have seen that the same 300 or 350 to 800 nm extended range can be covered by 5 LED types, but they are less preferred because the use of very broad range phosphor enhanced LEDs resulted in less adjustability.

We have also seen (as documented in the provisional priority document), that a roughly equivalent max power spectrum could be obtained at a lower parts cost by using less of the Channel IV to VII LEDs and driving them at a higher max current, and by substituting a less expensive equivalent version of the Channel I and II LEDs.

Alternative embodiments such as these are within the scope of the invention.

Selectable Spectral Output

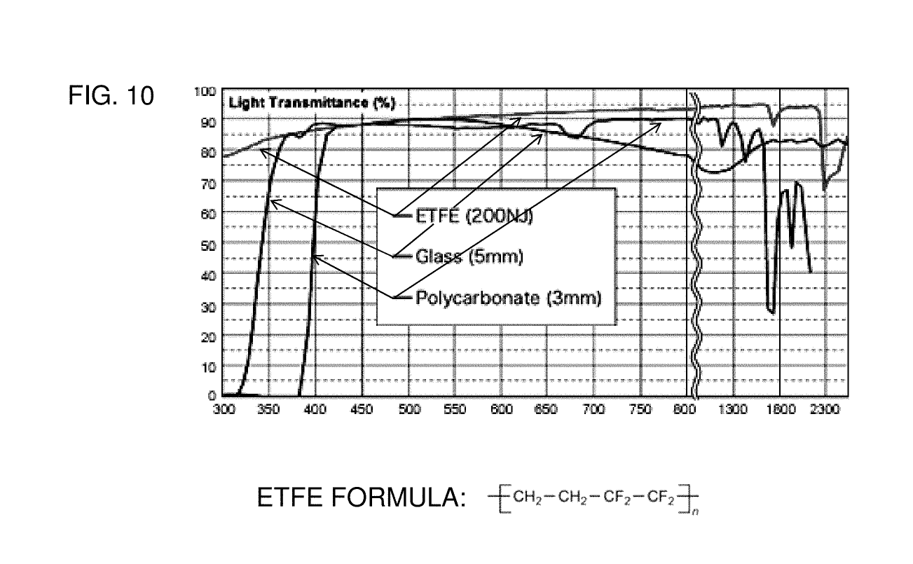

In many of the above types of lighting, it is desirable for the user to be able to easily switch among two or more selectable spectral outputs. In this way, a single light source could be used for different phases of plant growth, as selected by the gardener/horticulturalist. FIGS. 11A, 12A and 13A show embodiments wherein the spectrum selection may be made by using a manual switch/control 112 on the lamp housing 104, for example. Or, for example, the switching could be automated and/or centrally controlled (for a group of lights) by control circuitry, e.g., a Wi-Fi link between an external controller 112 and an internal LED driver 114 that is configured to separately adjust output for each of the multiple channels of LEDs 130.

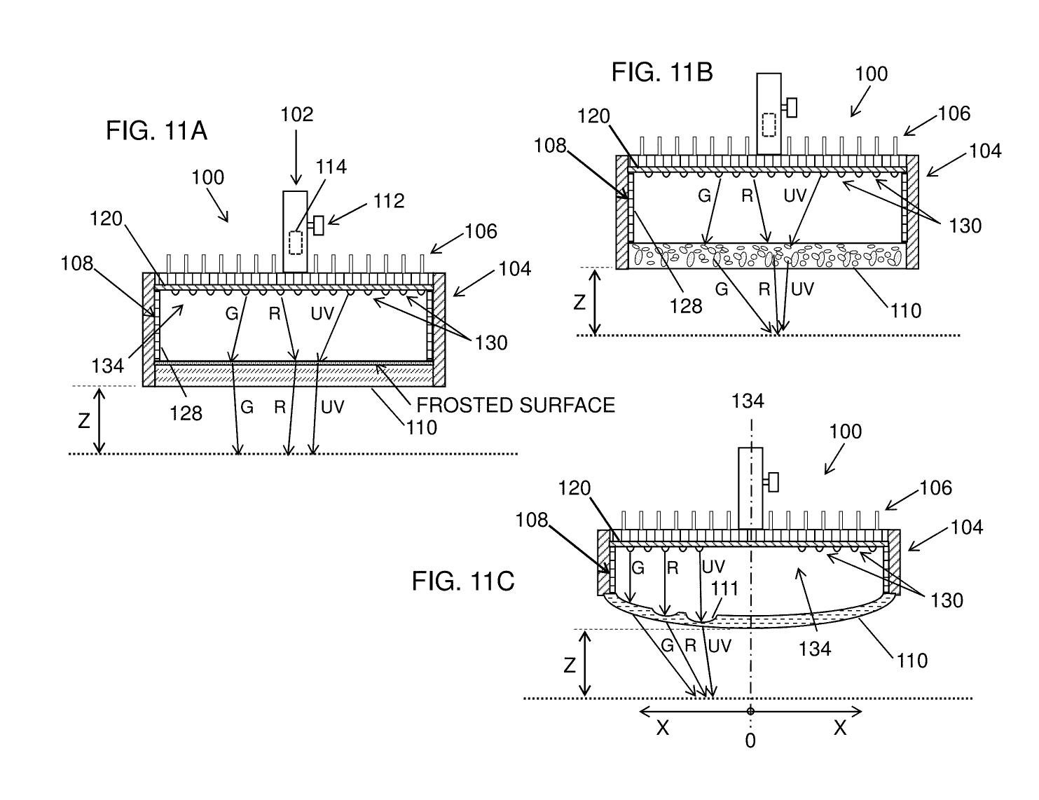

The switching control 112 may be effected by miniaturized LED driver circuitry 114, which may be combined with high efficiency LEDs 130 (which reduce needed driver current for the same light output). For example, an “on board” driver 114 may be used (see FIG. 12A).

LED Positioning in the Lamp

In FIG. 6 our layout of LEDs 130 is labeled 130a to 130f2 where the suffix a-f corresponds to positioning on the PCB/backplane 120 as concentric rings (except that f1 and f2 are in the same ring f). The LEDs for each channel are spaced apart uniformly around a single one of the ring, so the suffix also correlates with LED type (wavelength channel) as indicated in the table (FIG. 7). Only channels f1 and f2 share a ring, the innermost one, because they have the least number of LEDs. In general, channels were placed in rings according to the quantity of LEDs in the channel, so channel V which uses the most LEDs is in the outermost ring “a”, making them LEDs 130a.

The table in FIG. 7 also shows exemplary dimensional values for the ring radii X(a) to X(f). They are based on prototype lamp having a carrier/PCB 120 with a diameter Dpcb=19.0 cm (190 mm).

Diffusion and Color Mixing

Especially when even more channels are included in the light source (lamp) 100, there must be a way to mix colors to provide a uniform-appearing “color” in the radiation pattern, i.e., combining outputs of single wavelength (relatively narrow-band) point source LEDs even though they are spatially distributed on the LED carrier.

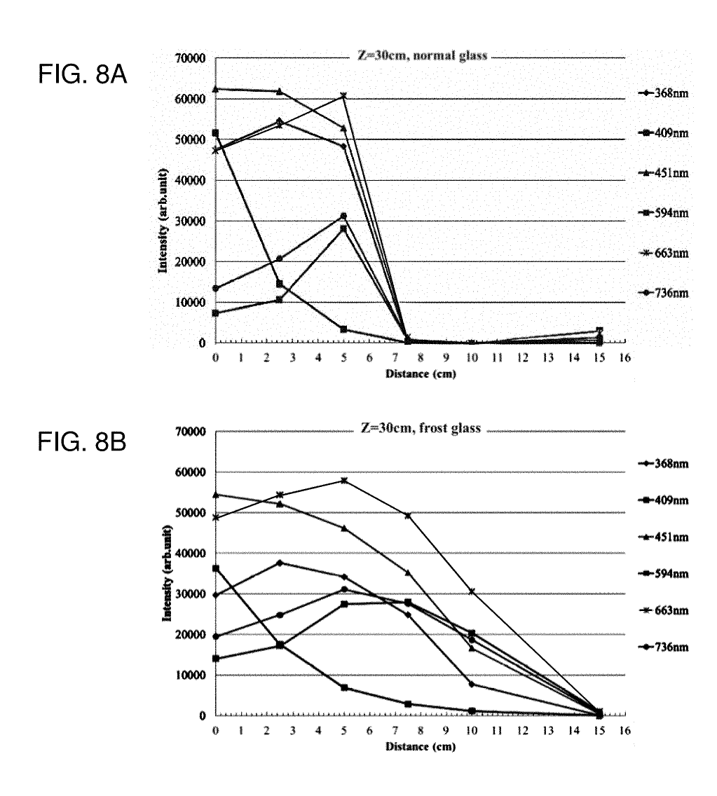

FIGS. 8A-9B show the need for color mixing to create a substantially uniform spectral distribution, especially when the plant canopy is relatively close to the lamp. For example, we intend the lamp to be used effectively as close as 30 cm (Z distance). Diffusion of the lens and/or reflector(s) is used to even out the intensity distribution and to uniformly mix all the colors.

One way is by using a diffusing reflector 128 as shown in FIGS. 12A-12C where it is positioned on the inside wall 108 around the LED module 136, and/or on top of the PCB 120 (with holes for the LEDs 130). The detail view of FIG. 12B shows that the LED 130 is mounted on circuit traces 124 that are separated from the underlying metal PCB by a dielectric layer 122. The PCB is mechanically and thermally bonded to the lamp body 104 which forms a part of the heat sink. An optional solder mask 126 may lie between the circuit traces and the reflector 128.

The diffusing reflector 128 could simply be a rough reflective surface, but preferably is a sheet of PTFE type of fluoropolymer which reflects off of a crystalline internal structure as illustrated in FIG. 12C. PTFE has a 95%+reflectance in the 300 nm to 850 nm range.

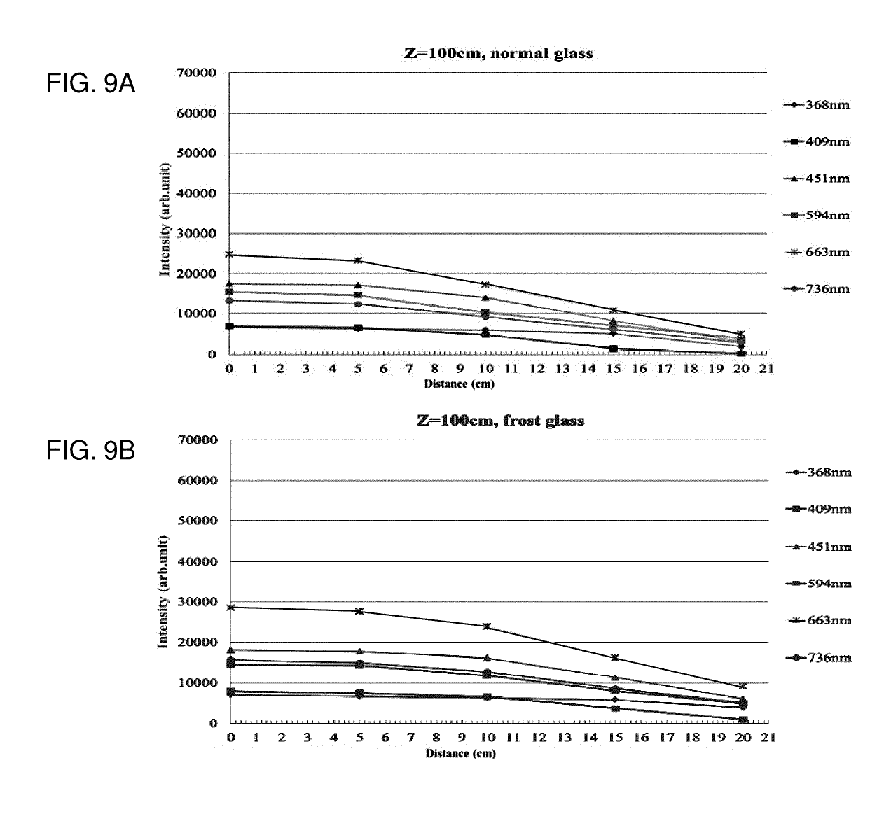

Note that FIG. 10 shows ETFE type of fluoropolymer which has much less crystalline structure so it has 80-90% transmittance over 300-800 nm range.

PTFE is a prime example of a polymer having a crystalline structure that diffuses light. Other examples may include PVDF, ETFE, and PFE; however the PTFE has the best crystalline structure for reflective diffusion, and ETFE is best for transmissive diffusion. These are all in a general class of “fluoropolymers”.

Depending upon thickness and optional presence of a reflective back surface or separate reflector positioned behind, the crystalline polymer can be made translucent and/or reflective. If translucent, it can be made into a lens at the front of a multi-spectrum lamp.

In the prior art the use of a crystalline polymer (e.g., polycarbonate/PC with embedded beads) is known for diffusing transmission of visible light, but not UV such as UVA in the range of 350-400 nm. The present invention has found a way to achieve the desired effect for its UVA channel, i.e., by using a fluoropolymer lens.

With reference to FIGS. 5-6 and 11-13 a novel design is presented for a multi-spectrum lamp. FIG. 12C is a vertical cross-sectional view of a schematic representation. It illustrates diffuse scattering due to the crystal structure of the fluoropolymer lens.

Diffusion to Even Out the Intensity Distribution and to Mix Colors

Some testing was conducted using a glass lens/cover. FIGS. 8-9 compare clear glass to frosted. The clear glass protectively encloses the LEDs, but does not diffuse and mix very well—especially at the closer Z-distance. As disclosed above, a fluoropolymer lens does a good job of diffusing. Another advantage of using a polymer is that they can be molded into other shapes that may be better at distributing light, so FIG. 10 shows the transmittance versus wavelength of glass versus two polymers. Polycarbonate would be relatively simple/inexpensive to use but has a completely unacceptable cutoff of UVA below about 400 nm. Glass is better for UVA but still shows a drop. Glass also has a significant drop in transmittance going into IR. The ETFE, however, has excellent transmittance over the entire range of wavelengths that we want.

Regarding the ETFE: The gradual decrease in UV region is due to Fresnel loss with RI increase when wavelength decreases. A 3.3 mm thick coupon is a Lambertian diffuser (FWHM 120 deg) but is too strong. We have better results with 2 mm-2.5 mm thick coupons.

If UV not needed, good diffusion was obtained using a polycarbonate molded polymer lens that had beads blended into it.

FIG. 5 is a rendering of the SP170 lamp with a dome-shaped lens molded using ETFE fluoropolymer that has a crystalline structure to give good diffusion. We expect the optimum to be in the range of 1-2 mm thick. The prototype lamp has an OD of 260 mm and an OAL OF 300 mm.

We have identified a good source for moldable fluoropolymer materials who is willing to work with us to customize according to our needs. We believe the combination of a fluoropolymer diffusing lens with multichannel LEDs including UVA (down to about 350 nm) and far red (up to 800 nm) provides a unique product opportunity for applications including horticultural.

Thermal Aspects of Lamp

Learning from the traditional HID lamp, heat flux from the lamp 100 is sometimes helpful for plant growth. Thus, how to guide heat flux through the air and uniformly transfer to the growing plants should be part of any considerations for thermal management.

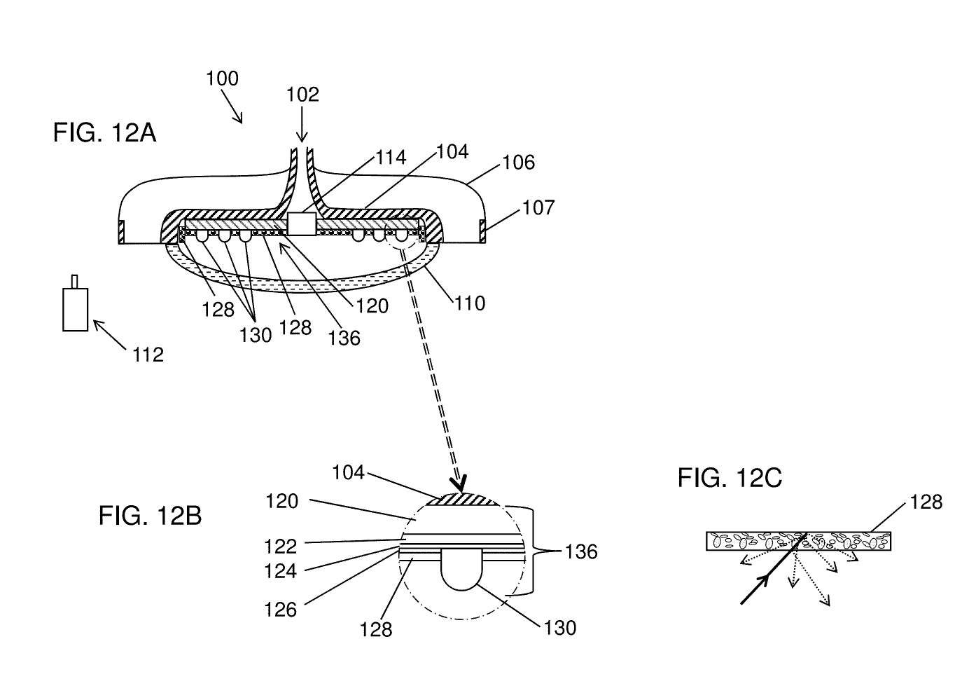

A temperature sensing feedback circuit (not shown) may be located where it can control air temperature to avoid overheating plants. Referring to FIGS. 13A-13B, it could be combined with active cooling of the lamp 100, which otherwise relies on passive cooling by convective air flow up through and around heat sink fins 106. If a fan 146 is controlled to blow air down onto the top of the lamp the air will be heated as it flows through the cooling fins 106, reducing the temperature at the LED heat sink and providing additional driver cooling. The heated air will continue flowing down toward the plants as shown, and is directed downward by the deflector/outer ring 107.)

Since all of the radiant output of the lamp is directed downward, heat flux will be transferred to the plants via thermal radiation in the long wave infrared. Furthermore, heat will also be generated in any surface that absorbs other wavelengths of radiant energy from the lamp. The geometry and materials/surface treatment of the thermal management solution can be optimized to radiate maximum energy to the ground and plants, which are typically good absorbers of infrared radiation. This allows for effective heating of the plants despite air movement, and provides an additional means of heat dissipation for the LEDs.

Although the invention has been illustrated and described in detail in the drawings and foregoing description, the same is to be considered as illustrative and not restrictive in character—it being understood that the embodiments shown and described have been selected as representative examples including presently preferred embodiments plus others indicative of the nature of changes and modifications that come within the spirit of the invention(s) being disclosed and within the scope of invention(s) as claimed in this and any other applications that incorporate relevant portions of the present disclosure for support of those claims. Undoubtedly, other “variations” based on the teachings set forth herein will occur to one having ordinary skill in the art to which the present invention most nearly pertains, and such variations are intended to be within the scope of the present disclosure and of any claims to invention supported by said disclosure.

What is claimed is:

1. An LED grow lamp for lighting plants to encourage plant growth, comprising:
an LED that emits light having a peak magnitude in the UVA wavelength range of 315 to 400 nm (nanometers); and
a fluoropolymer lens positioned between the LED and the plant.

2. The LED grow lamp of claim 1 wherein:
a plurality of LEDs emitting a plurality of light wavelengths are discretely positioned and spaced apart on a backplane; and
the lens comprises ETFE fluoropolymer material that is configured to diffusely transmit the plurality of LED emissions for creating substantially uniform lighting independently of the plurality of LED discrete positions.
